(19) United States
(12) Patent Application Publication
(10) Pub. No.: US 2011/0073450 A1
(43) Pub. Date: Mar. 31, 2011

(54) Wall mounted switch extender

(75) Inventor: Oren Wass, Gedera (IL)

(73) Assignee: GOOLIMA L.T.D, Ramat Gan (IL)

(21) Appl. No.: 12/870,793

(22) Filed: Aug. 28, 2010

Related U.S. Application Data
(60) Provisional application No. 61/246,838, filed on Sep. 29, 2009.

(51) Int. Cl. H01H 3/02

(52) U.S. Cl. 200/331

(57) ABSTRACT

An extender for a wall mounted switch enabling the switch to be operated by short or disabled people, which otherwise would be difficult for them to reach or operate. The switch extender is composed of a switch adaptor, extender arm, wall mounted base guiding fixture and a handle, preventing it from moving to direction that may damage the apparatus or switch. The arm's length should be designed according to the height of the switch and the height of the person requiring the use of this apparatus. The switch extender should include a limiting fixture to prevent damage due to access stress. A locking pin may be used to prevent a toddler from operating the switch. The switch adaptor length may be varied to provide leverage to enable a toddler to operate a ‘hard moving’ switch.

### CROSS-REFERENCE TO RELATED APPLICATIONS

This is application claims the benefit of provisional patent application No. 61/246,838, EFS ID 6169710.

29Sep. 2009 by the present inventor.

### FEDERALLY SPONSORED RESEARCH

Not Applicable

### SEQUENCE LISTING OR PROGRAM

Not Applicable

### BACKGROUND

1. Field

This apparatus relates to a wall mounted switch extender for enabling toddlers, short or disabled people to operate a wall-mounted switch that would be otherwise out of reach.

2. Prior Art

Applicant is aware of the following U.S. patents pertaining to light switches adaptors, extenders and the like. U.S. Pat. No. 2,493,581 & U.S. Pat. No. 3,004,128 requires screws to connect it to the wall and is suited only for a specific type of switch. Additionally there is no fixture preventing pulling the arm away from the wall nor up and down thus damaging the apparatus. While U.S. Pat. No. 2,719,898 deals with the problem of damage to the device by pulling it away from the wall by a flexible axis it is easily dislocated by pulling on it and it is also designed to fit a single type of switch—it will not fir a flat surface switch. U.S. Pat. No. 2,726,303 prevent the accidental disconnection of the extension arm from the switch by using a screw providing a tight connecting but it too is only suitable for a single type of switch with a hole in it or connecting via a cap which may easily disconnect by a firm pull. It will not fit flat surface switches. U.S. Pat. No. 3,722,319 & U.S. Pat. No. 4,256,943 are very simple type of switch extenders made of a arm connected to cap which connects to the switch—these are easily removed from the switch by pulling on them and are only suited to a single type of switch. U.S. Pat. No. 3,839,615 also required screws and is suited for single type of switch. U.S. Pat. No. 3,916,134 is a simple bend metal which is specifically designed for a specific switch where the location of the switch screws are in an exact location compared to the switch—this too is only suited for 1 type of switch and cannot connect to flat surface switches. U.S. Pat. No. 4,590,345 requires the removal of the light switch cover and should only be done by an electrician—furthermore it is only suited for a single type switch and has no leveraging benefit. It can easily break or bend by pulling away from the wall. U.S. Pat. No. 4,870,232 & U.S. Pat. No. 5,017,746 are comprised of a simple arm that is suited for a single type of switch, they require the removal of the screws fastening the electrical switch cover which must match the screws or screw location of the extender device kit. U.S. Pat. No. 5,055,645 is also suitable for a single type of switch and may be easily disconnected by a chilled pulling on it. U.S. Pat. No. 5,380,967 has an easy & fast connection via double sided tape but it too is only suitable for a single switch type, does not leverage mechanism to enable the operation of hard moving switches by toddlers U.S. Pat. No. 5,396,037 is a battery operated extender where a signal passing via the rod activated the light switch—this design is an electrical device much more expensive to manufacture and is limited to the life of the battery, furthermore it is not suitable to different types of switches. U.S. Pat. No. 5,451,734 is also suited for single type of switch and requires the switch screws removal and perfect alignment to the apparatus limiting its usage. U.S. Pat. No. 6,036,330 requires the screw removal from the switch to be assembled through the apparatus and is also only suited for a specific type of switch.

While the above patents show different forms of wall-mounted switch extenders and adaptors the structures are either difficult to install requiring dismantling the switch cover, risking electrocution or fire in case of incorrect assembly. All above are suitable only for a protruded “US style” switch and will not fit any flat or semi flat surface switch. Many of them are easily dismantled during normal operation or are very fragile. Almost none of them provide leverage to assist a toddler operate hard moving switches. None have a mechanism to restrict movement of the switch extender to the limits of the switch thus prone to a very short life span of the apparatus.

The presented invention has an objective to provide an apparatus which is simple and cheap to manufactured and very easy to install within several seconds where no special technical qualifications or capabilities are required. Installing this apparatus has no risk of electrical shock from wall switch because there is no need to remove the cover or rewire the wall switch. It additionally provides benefits as the ability to generate leverage to help toddlers operate hard moving switches, an optional locking pin to prevent unwanted misuse by toddlers and an integrated limiting fixture to prevent damage to the switch or apparatus when using excess force. The extender is easily modified to suit almost all wall mounted switches via an upper switch adaptor—all in a robust an appealing design.

### SUMMARY

In accordance with one embodiment a switch extender comprises of a switch adaptor, an arm extender, a base unit and a movement limiting element.

### DRAWINGS

### Figures

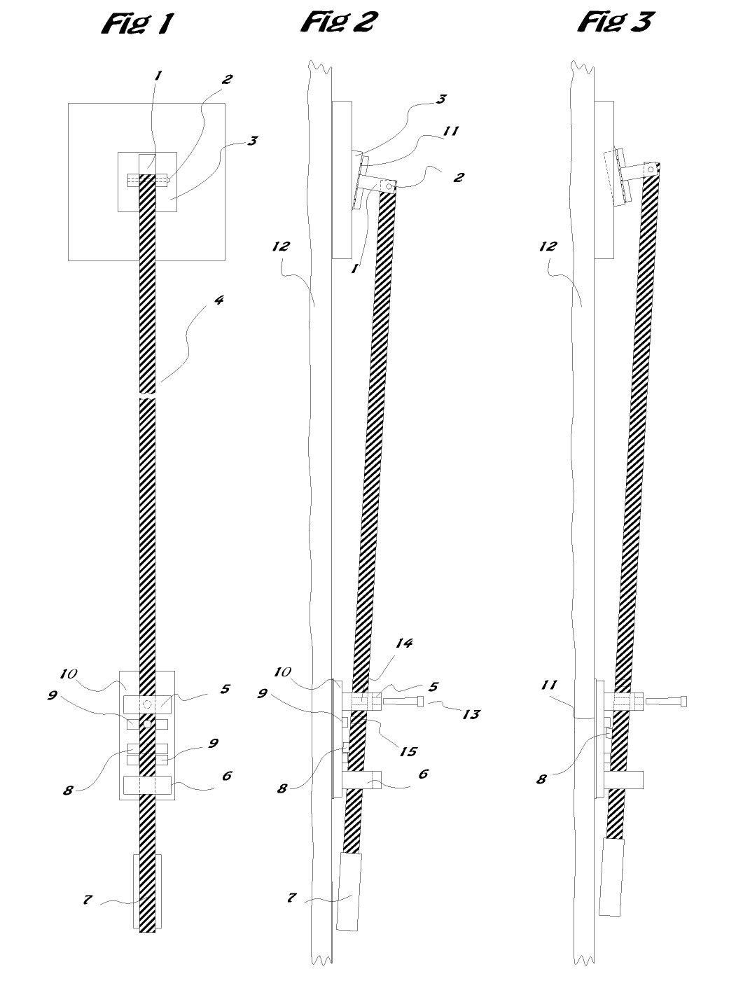

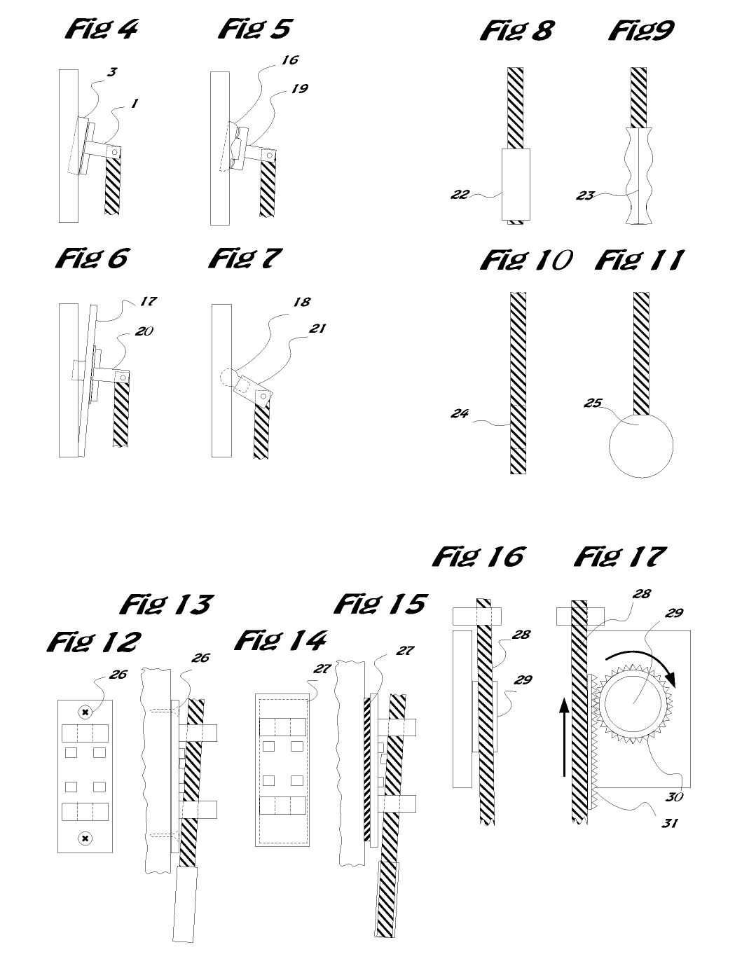

FIG. 1 shows the front view of switch extender connected on the top to a wall mounted switch.

FIG. 2 shows the side view of wall mounted switch extender connected on the left to a wall and wall-mounted switch. The switch extender is in the “down” position.

FIG. 3—shows the side view of wall mounted switch extender connected on the left to a wall and wall-mounted switch. The switch extender is in the “up” position.

FIGS. 4 to 7 show various types of wall mounted switches and switch adaptors.

FIGS. 8 to 11 show various types of swift extender handles.

FIG. 12 shows the front view of the wall mounted guide base with screws as the connecting means to the wall.

FIG. 13 shows the side view of the wall mounted guide base with screws as the connecting means to the wall.

FIG. 14 shows the front view of the wall mounted guide base with double sided tape as the connecting means to the wall.

FIG. 15 shows the side view of the wall mounted guide base with double sided tape as the connecting means to the wall.

FIG. 16 shows the side view of the switch adaptor with saw tooth tape used to connect the extender arm to a rotary switch.

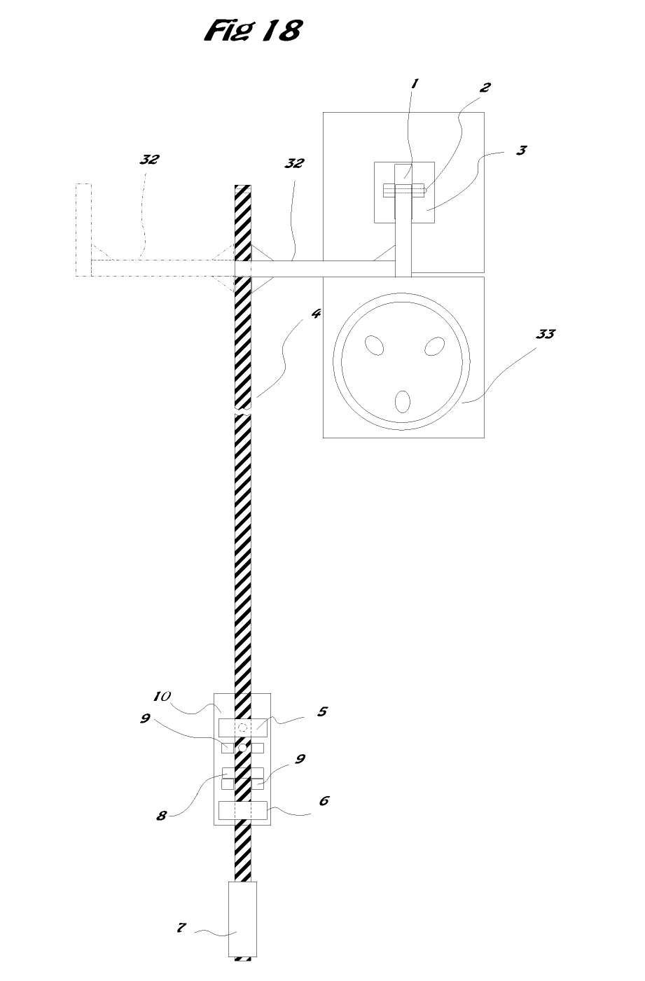

FIG. 17 shows the front view of the switch adaptor with saw tooth tape used to connect the extender arm to a rotary switch.

FIG. 18 shows a wall mounted switch extender with a switch adaptor in a 90° angle enabling the operation of the switch yet leaving the area bellow it available for use.

### DRAWINGS

### Reference Numerals

1—Switch adaptor
2—Switch adaptor axis
3—Wall mounted switch.
4—Extender arm
5—Upper extender guide
6—Lower extender guide
7—Handle
8—Arm stopper
9—Movement limiters
10—Wall mount guide base
11—Bonding material
12—Wall
13—Optional location locking pin
14—Upper locking hole
15—Lower locking hole
16—Switch type 1
17—Switch type 2
18—Switch type 3
19—Switch adaptor type 1
20—Switch adaptor type 2
21—Switch adaptor type 3
22—Handle type 1
23—Handle type 2
24—Handle type 3
25—Handle type 4
26—Screw
27—Double sided tape
28—Extender arm
29—Dimmer turning switch
30—Saw tooth sticky tape wrapped on dimmer or rotary switch
31—Saw tooth sticky tape connected to extender arm
32—Right angle arm
33—Wall electric socket

### DETAILED DESCRIPTION

FIG. 1 illustrates the front view of the switch extender connected on the top side to a wall mounted switch and on the bottom to the surface of the wall.

FIG. 2 shows the side view of the switch extender in the down position and FIG. 3 shows the switch in the up position. The wall-mounted switch (3) is connected to the switch adaptor (1) and then through an axis (2) to the main extender arm (4). The arm runs through the stabilizing wall-mounted unit, which comprises of a wall mounted guide base (10), an upper extender guide (5) a lower extender guide (6) and two movement limiters (9). The arm stopper (8) is connected to the main extender arm (4). A handle (7) that connects or is part of the bottom of the extender arm (4), several types may be used (22-25). Double-sided tape (11) connects the switch (3) to the switch adaptor (1). Optional location-locking pin (13) may be placed in the down limiting hole (14) or up limiting hole (15). Different types of switch adaptors may be used (1, 19, 20, and 21) for several types of wall-mounted switches (2, 16, 17, and 18). Saw tooth sticker tape glued to the extender arm (31) and around rotary switches (30).

### Operation

The apparatus is operated by moving the handle (7) on the bottom of the main extender arm (4) up and down. The extender arm routed thought the stabilizing wall-mounted unit which prevents the arm from moving sideways and guides it in the correct direction. The movement limiters (9) along with the arm stopper (8) are used to prevent the extender from moving too much in the up or down direction thus prevent it from disconnecting from the switch or breaking The limiting is done by the ‘arm stopper’ (8) which is connected to or part of the extender arm (4) and stops the arm from moving beyond the limits of the up and down movement limiters (9). The upper and lower extender guilds (5,6) may be used as movement limiters thus removing the need for one or two of the limiters (9). The handle (7) is used to enable easy operation of the extender.

Two-sided tape (11) may be used to easily connect the switch adaptor (1) to the switch (3) and to connect the guide base (10) to the wall (12).

An optional location-locking pin (13) may be used to prevent toddlers from operating the switch by locking it in either the up position (15) or down position (14) holes.

FIG. 4 to FIG. 7 display several switch adaptors (1,19,20,21) to enable it to connect to different types of wall-mounted switches (2,16,17,18).

FIG. 8 to FIG. 11 display several handles that may be used to enable easy operation of the switch extender by providing simple (22), elegant (23), finger hole (24), ball end (25) or alternative designs.

FIG. 12 to FIG. 15 show two possible methods to attaché the switch extender to the wall. A screw (26) connection (FIG. 12—front view, FIG. 13—Side view) which provides a stronger connection but longer to assemble yet may still be easy to install on wooden walls. Double sided tape (27) connection provides a fast, easy and fairly strong wall connection (FIG. 14—front view, FIG. 15—Side view). Additional adhesives may be used including glues, plaster rubber etc'.

The switch extender can be adapted to operate additional types of switches.

An example of connecting to a dimmer-turning switch (29) may be seen in FIG. 16 (side view) and FIG. 17 (Front view).

In this example a saw tooth sticker tape (30,31) is used to wrap the dimmer and to connect to the extender (28) along with an upper guide, which enable it to turn the dimmer on and set the required light intensity, fan speed etc'.

A right angle lever adaptor (32) may be fitted to the apparatus to enable toggling a wall mounted switch without blocking a usable area, for example—an electric socket (33).

### CONCLUSION, RAMIFICATIONS, AND SCOPE

Thus the reader will see that at least one embodiment of the apparatus provides a more reliable, easily installable, versatile solution to the problem toddlers may have to reach a wall mounted switch.

While my above description contains many variations in switch adaptors types, handle types, length and variations enabling it to operate in versatile manners—these should not be considered limitations but rather exemplification of preferred embodiment thereof. Many other variations are possible. For example—different type of switch adaptors may be suited for new or other switches which do not appear in the figures above. One extender may operate two or more switches. Size and length may vary. The apparatus may be made of different type of material as wood, plastic or Accordingly, the scope should be determined not by the embodiment(s) illustrated, but by the appended claims and thier legal equivalents.”

1. A wall mounted remote switch operating apparatus comprising:
1. A switch adaptor connected to a wall mounted switch and pivotally to an extending arm.
2. Said extending arm connected to said switch adaptor on the upper side and limited by a base unit fixed to the wall which enables its free movement up and down.
3. Said base unit that connects to the wall and limits said extender arm from moving to directions that may cause the apparatus to malfunction.
4. A limiting element on the base unit that limits the up or down movement over an extent that may cause the apparatus to fail in its normal use.
